(19) United States
(12) Patent Application Publication
(10) Pub. No.: US 2025/0146980 A1
(43) Pub. Date: May 8, 2025

(54) ROBOTIC WEDGE MANIPULATION FOR DEPOSIT OR REMOVAL

(71) Applicant: Evident Canada, Inc., Québec (CA)

(72) Inventor: Dominique Nogues, Québec (CA)

(21) Appl. No.: 18/837,641

(22) PCT Filed: Feb. 14, 2023
(86) PCT No.: PCT/CA2023/050187

§ 371 Date: Aug. 12, 2024

Related U.S. Application Data
(60) Provisional application No. 63/268,012, filed on Feb. 15, 2022.

(51) Int. Cl. G01N 29/265; G01N 29/04

(52) U.S. Cl. CPC G01N 29/265; G01N 29/04; G01N 2291/0289; G01N 2291/106; G01N 2291/2675

(57) ABSTRACT

Apparatus and techniques as shown and described herein can be used to provide non-destructive inspection using a scanner assembly that can have one or more arms that can be used to position a probe assembly such that full inspection coverage of a structure can be achieved in a semi-automated or automated manner using as few as a single scanner assembly. Such apparatus and techniques can include a scanner assembly having multiple arms and corresponding probe assemblies, such as can be used to perform acoustic inspection of a longitudinal weld structure.

### CLAIM OF PRIORITY

This patent application claims the benefit of priority of Nogues, U.S. Provisional Patent Application No. 63/268,012, titled “ROBOTIC WEDGE MANIPULATION FOR DEPOSIT OR REMOVAL,” filed on Feb. 15, 2022 (Attorney Docket No. 6409.229PRV), which is hereby incorporated by reference herein in its entirety.

### FIELD OF THE DISCLOSURE

This document pertains generally, but not by way of limitation, to apparatus and techniques for non-destructive inspection such as facilitating acoustic inspection, and more particularly, to apparatus and techniques for robotically assisted manipulation of an acoustic probe assembly to facilitate more complete coverage of a structure being inspected.

### BACKGROUND

Non-destructive testing (NDT) can refer to use of one or more different techniques to inspect regions on or within an object, such as to ascertain whether flaws or defects exist, or to otherwise characterize the object being inspected. Examples of non-destructive test approaches can include use of an eddy-current testing approach where electromagnetic energy is applied to the object and resulting induced currents on or within the object are detected, with the values of a detected current (or a related impedance) providing an indication of the structure of the object under test, such as to indicate a presence of a crack, void, porosity, or other inhomogeneity.

Another approach for NDT can include use of an acoustic inspection technique, such as where one or more electroacoustic transducers are used to insonify a region on or within the object under test, and acoustic energy that is scattered or reflected can be detected and processed. Such scattered or reflected energy can be referred to as an acoustic echo signal. Generally, such an acoustic inspection scheme involves use of acoustic frequencies in an ultrasonic range of frequencies, such as including pulses having energy in a specified range that can include value from, for example, a few hundred kilohertz, to tens of megahertz, as an illustrative example.

### SUMMARY OF THE DISCLOSURE

Apparatus and techniques as shown and described herein can be used to provide non-destructive inspection using a scanner assembly that can have one or more arms that can be used to position a probe assembly such that full inspection coverage of a structure can be achieved in a semi-automated or automated manner using as few as a single scanner assembly. Such apparatus and techniques can include a scanner assembly having multiple arms and corresponding probe assemblies, such as can be used to perform acoustic inspection of a longitudinal weld structure.

In one approach, a robotic manipulator can be used to facilitate acoustic inspection, such as to perform inspection of a longitudinal weld structure using multiple acoustic probes. For example, use of a robotic manipulator and scanner head having multiple degrees of freedom can allow deposit (e.g., landing) of an active surface of an acoustic probe on a structure to be inspected. Such a robotic manipulator arrangement can also be used to facilitate lift-off of the respective acoustic probes. In an example, a height and inclination angle of an active surface of an acoustic probe can be controlled, such as independently of other probes in the scanner assembly. Such an approach can provide one or more capabilities, such as facilitating more complete coverage of a structure being inspected or avoiding damage to the probe assembly or structure being inspected.

In an example, a scanner assembly can include a support frame, a first probe holder, a first probe assembly mechanically coupled with the first probe holder and configured to pivot relative to the first probe holder, and a first arm mechanically coupled to the support frame and configured to slide relative to the support frame to translate the first probe holder relative to the support frame. The first probe assembly can pivot from a first orientation to a second orientation as the first arm slides, to align the first probe assembly in the second orientation to scan an object under test. In an example, the first orientation comprises an inclined orientation relative to a surface of the object under test, and the second orientation comprises an orientation parallel to the surface of the object under test. In an example, the first probe assembly comprises at least one acoustic transducer.

In an example, a method for performing non-destructive test (NDT) can include robotically manipulating a support frame of the scanner assembly, the support frame coupled to a first arm, the first arm coupled to a first probe holder, the manipulating comprising translating the support frame toward an object under test, sliding the first arm relative to the support frame to translate the first probe holder relative to the support frame, and pivoting the first probe assembly from a first orientation to a second orientation relative to the first probe holder, as the first arm slides, to align the first probe assembly in a second orientation to scan the object under test without colliding with an end of the object under test. The first orientation can include an inclined orientation relative to a surface of the object under test, and the second orientation can include an orientation parallel to the surface of the object under test.

This summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example comprising an acoustic inspection system, such as can be used to perform at least a portion one or more techniques as shown and described herein.

FIG. 2A illustrates generally a scanner configuration and associated acoustic probe assembly configuration, such as can be used to inspect a structure such as a longitudinal weld.

FIG. 2B illustrates generally another scanner configuration and associated acoustic probe assembly configuration, such as can be used to inspect a structure such as a longitudinal weld.

FIG. 3A, FIG. 3B, FIG. 3C, and FIG. 3D illustrates a portion of a scanner assembly in various configurations, such as facilitating full inspection coverage of an object under test using a pivoting inspection probe assembly and an arm coupled with a support frame.

FIG. 4 illustrates generally an example comprising a scanner assembly having a plurality of arms supporting corresponding inspection probe assemblies, such as having arms that can be operated in a manner similar to the configurations shown illustratively in FIG. 3A, FIG. 3B, FIG. 3C, FIG. 3D.

FIG. 5A and FIG. 5B illustrate generally an example comprising a scanner assembly similar to FIG. 4, shown in two different configurations, such as to provide deployment or lift-off of respective inspection probe assemblies.

FIG. 6 illustrates generally a technique, such as an automated method, that can include manipulating a support frame of a scanner assembly, amongst other operations.

### DETAILED DESCRIPTION

Non-destructive inspection can include use of automated or semi-automated inspection apparatus. For example, an acoustic inspection technique can be used to inspect weld structures such as forming a part of large vessels, tankage, or other structures, such as rocket fuselages. In an example, such acoustic inspection can include use of multiple acoustic probe arrays to perform longitudinal weld inspection. In one approach, such inspection can be performed using fully independent inspection probe heads that are independently positionable using pneumatic actuators or by hand. Such an approach can present challenges. For example, the present inventor has recognized that using completely independent probe assemblies (e.g., probe assemblies that are not coupled to each other using a common frame or other common scanner assembly) can add one or more of weight, material, or cost to the scan equipment. Throughput (e.g., a rate at which desired or required inspection coverage can be achieved) can also be impacted if such probes are positioned fully independently, due to set-up complexities (e.g., forming scribed lines or other indicia to facilitate probe tracking) or rework (e.g., re-scanning of areas that were missed or not properly inspected during a first pass), as illustrative examples.

The present inventor has developed apparatus and techniques as shown and described herein to provide non-destructive inspection using a scanner assembly that can have one or more arms that can be used to position a probe assembly such that full inspection coverage of a structure can be achieved in a semi-automated or automated manner using a single scanner assembly. Such apparatus and techniques can include a scanner assembly having multiple arms and corresponding probe assemblies, such as can be used to perform acoustic inspection of a longitudinal weld structure.

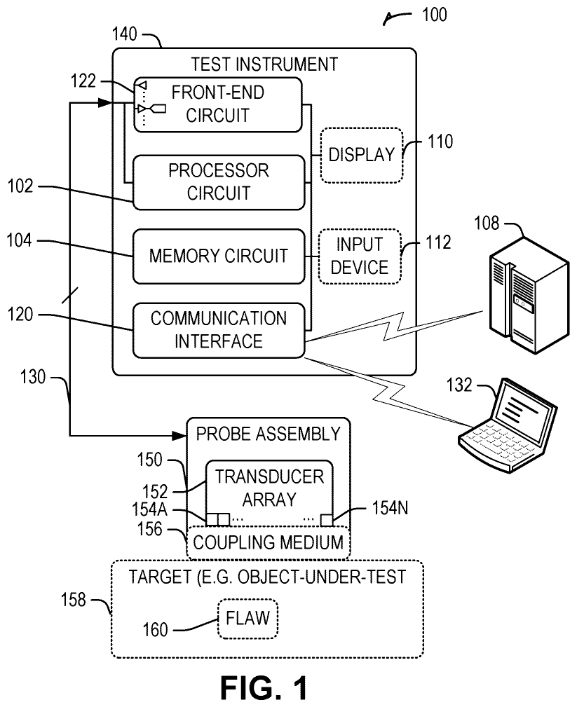

FIG. 1 illustrates generally an example comprising an acoustic inspection system 100, such as can be used to perform at least a portion one or more techniques as shown and described herein. The acoustic inspection system 100 can include a test instrument 140, such as a hand-held or portable assembly, or other configuration. The test instrument 140 can be electrically coupled to a probe assembly 150, such as using a multi-conductor interconnect 130. The probe assembly 150 can include one or more electroacoustic transducers, such as a transducer array 152 including respective transducers 154A through 154N. The transducers array can follow a linear or curved contour or can include an array of elements extending in two axes, such as providing a matrix of transducer elements. The elements need not be square in footprint or arranged along a straight-line axis. Element size and pitch can be varied according to the inspection application.

A modular probe assembly 150 configuration can be used, such as to allow a test instrument 140 to be used with various different probe assemblies. As shown and described below, a scanner assembly can be used to apply one or more such probe assemblies 150 contemporaneously in coordination with each other for performing non-destructive inspection. Generally, the transducer array 152 includes piezoelectric transducers, such as can be acoustically coupled to a target 158 (e.g., a test specimen or “object-under-test”) through a coupling medium 156. The coupling medium can include a fluid or gel or a solid membrane (e.g., an elastomer or other polymer material), or a combination of fluid, gel, or solid structures. For example, an acoustic transducer assembly can include a transducer array coupled to a wedge structure comprising a rigid thermoset polymer having known acoustic propagation characteristics (for example, Rexolite® available from C-Lec Plastics Inc.), and water can be injected between the wedge and the structure under test as a coupling medium 156 during testing, or testing can be conducted with an interface between the probe assembly 150 and the target 158 otherwise immersed in a coupling medium.

The test instrument 140 can include digital and analog circuitry, such as a front-end circuit 122 including one or more transmit signal chains, receive signal chains, or switching circuitry (e.g., transmit/receive switching circuitry). The transmit signal chain can include amplifier and filter circuitry, such as to provide transmit pulses for delivery through an interconnect 130 to a probe assembly 150 for insonification of the target 158, such as to image or otherwise detect a flaw 160 on or within the target 158 structure by receiving scattered or reflected acoustic energy elicited in response to the insonification. While FIG. 1 shows a single probe assembly 150 and a single transducer array 152, other configurations can be used, such as multiple probe assemblies connected to a single test instrument 140, or multiple transducer arrays 152 used with a single probe assembly 150 or multiple probe assemblies for pitch/catch inspection modes. Similarly, a test protocol can be performed using coordination between multiple test instruments 140, such as in response to an overall test scheme established from a controlling test instrument 140 or established by another remote system such as a compute facility 108 or general-purpose computing device such as a laptop 132, tablet, smart-phone, desktop computer, or the like. The test scheme may be established according to a published standard or regulatory requirement and may be performed upon initial fabrication or on a recurring basis for ongoing surveillance, as illustrative examples.

The receive signal chain of the front-end circuit 122 can include one or more filters or amplifier circuits, along with an analog-to-digital conversion facility, such as to digitize echo signals received using the probe assembly 150. Digitization can be performed coherently, such as to provide multiple channels of digitized data aligned or referenced to each other in time or phase. The front-end circuit can be coupled to and controlled by one or more processor circuits, such as a processor circuit 102 included as a portion of the test instrument 140. The processor circuit 102 can be coupled to a memory circuit 104, such as to execute instructions that cause the test instrument 140 to perform one or more of acoustic transmission, acoustic acquisition, processing, or storage of data relating to an acoustic inspection, or to otherwise perform techniques as shown and described herein. The test instrument 140 can be communicatively coupled to other portions of the acoustic inspection system 100, such as using a wired or wireless communication interface 120.

For example, performance of one or more techniques as shown and described herein can be accomplished on-board the test instrument 140 or using other processing or storage facilities such as using a compute facility 108 or a general-purpose computing device such as a laptop 132, tablet, smart-phone, desktop computer, or the like. For example, processing tasks that would be undesirably slow if performed on-board the test instrument 140 or beyond the capabilities of the test instrument 140 can be performed remotely (e.g., on a separate system), such as in response to a request from the test instrument 140. Similarly, storage of imaging data or intermediate data such as A-scan matrices of time-series data or other representations of such data, for example, can be accomplished using remote facilities communicatively coupled to the test instrument 140. The test instrument can include a display 110, such as for presentation of configuration information or results, and an input device 112 such as including one or more of a keyboard, trackball, function keys or soft keys, mouse-interface, touch-screen, stylus, or the like, for receiving operator commands, configuration information, or responses to queries.

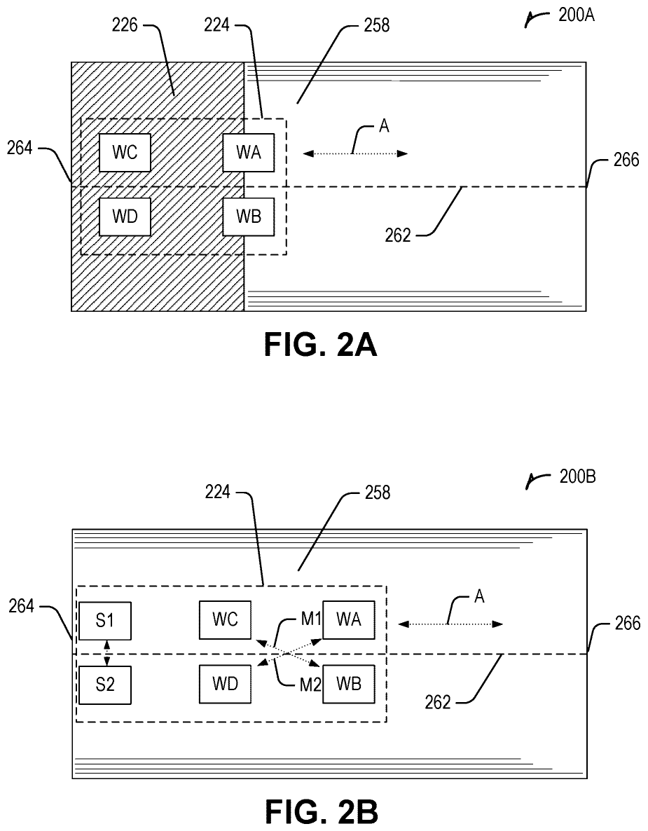

As described herein, use of electroacoustic transducer can include phased-array inspection approaches or other inspection techniques, such as time-of-flight diffraction (TOFD). Other sensing modalities can be used in addition to acoustic transducers, or instead of acoustic transducers. FIG. 2A illustrates generally a scanner configuration 200A and associated acoustic probe assembly configuration, such as can be used to inspect a structure such as a longitudinal weld 262 along an object under test 258. In the illustrative example of FIG. 2A, respective inspection probe assemblies WA, WB, WC, and WD can house acoustic transducer arrays. The use of four inspection probe assemblies is merely illustrative, and other counts of inspection probes can be used (e.g., a single probe, two probes, ten probes, or other counts). In one approach, as mentioned above, such inspection probe assemblies WA, WB, WC, and WD may be positioned individually or collectively using a scanner assembly 224. In such an approach, it may be necessary to deploy (e.g., land) the probe assemblies WA, WB, WC, and WD on a surface of the object under test 258 at a location along the weld 262 away from a leading edge 264, to avoid a collision between the probe assemblies WA, WB, WC, and WD. This can result in incomplete coverage in the region 226 along the weld 262, because each of the probe assemblies WA, WB, WC, and WD may touchdown upon the surface of the object under test 258 away from the leading edge 264. For example, to avoid a collision with the leading edge 264, a respective probe assembly WA may be deposited on the surface of the object under test 258 well away from the leading edge 264. Because the probe is not in contact or otherwise aligned for scanning an entirety of the length of the weld 262, coverage in the region 226 can be incomplete (e.g., an entirety of the longitudinal weld 262 extent along the object under test 258 may not be covered during an inspection scan). Accordingly, to achieve coverage of the full extent of the weld 262, a separate manual inspection or probe positioning may be needed, which can reduce overall inspection throughput (e.g., a rate at which the weld 262 inspection can be performed), or may even preclude full coverage of the weld 262 along an entirety of the weld 262 length.

The present inventor has developed apparatus and techniques as shown and described herein, such as to provide more complete coverage of the weld 262, such as providing deployment of one or more probe assemblies WA, WB, WC, or WD at the leading edge 264, without collision with the leading edge 264. The scanner assembly 224 can translate the acoustic probe assemblies WA, WB, WC, WD along the weld 262 in a direction indicated by the axis A, such as to provide coverage until such probes WA, WB, WC, and WD are lifted off at or near the trailing edge 266 of the object under test or at the leading edge 264 in an example where a bi-directional scan path is used. As an illustrative example, the object under test 258 can include a vessel (such as a pressure vessel) or a fuselage of a structure such as a portion of a cylindrical rocket body.

As another illustration, FIG. 2B illustrates generally a scanner configuration 200B and associated acoustic probe assembly configuration, similar to FIG. 2A. In FIG. 2B, a scanner assembly 224 can include one or more sensors (such as S1 and S2), such as to assist in automatically aligning the scanner assembly 224 or otherwise aiding a user in aligning the scanner assembly 224 for inspection of a weld 262. Such a scanner assembly 224 can include one or more of an optical or ultrasonic sensor, separate from acoustic probe assemblies WA, WB, WC, and WD. Attributes that can be determined using the sensors S1 or S2 can include a distance or height of a scanner assembly 224 from a surface, a presence of an obstacle, a location of a feature on the surface (e.g., a weld edge or a weld center line), or tracking of an indicium on the surface such as a line or other indication. In the configurations 200A and 200B of FIG. 2A and FIG. 2B, the scanner assembly 224 can support various inspection modes, such as for acoustic inspection of the weld 262. For example, acoustic modes can be supported where an acoustic pulse is generated and received by a single acoustic probe assembly. Other modes can be used, such as where an acoustic pulse is transmitted from one probe and another probe is used for receiving (e.g., WA to WB, WC to WD, or vice versa). Other configurations can be used, such as down illustratively by the axes M1 and M2, indicating that probe WB can transmit and probe WC can receive, probe WA can transmit and probe WD can receive, or vice versa. Accordingly, in the examples described in this document, a scanner configuration can be used supporting as few as a single probe in a transmitting and receiving mode, or various configurations such as pitch/catch modes or tandem inspection configurations. The examples below show more detailed illustrations of a scanner assembly coupled to respective probe assemblies that can pivot relative to arms, where the arms are mechanically coupled with a support frame and can slide relative to the support frame, such as in a spring-loaded manner.

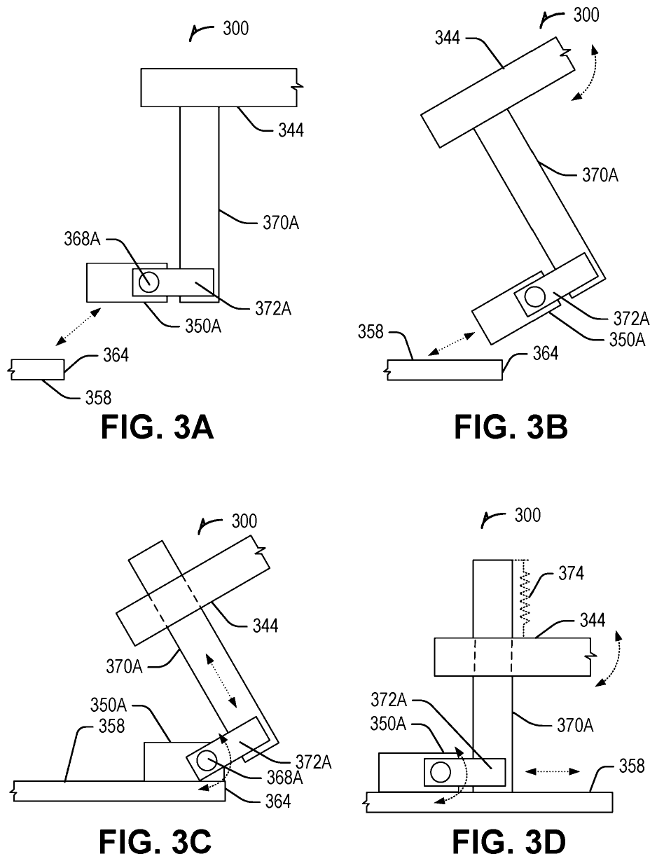

FIG. 3A, FIG. 3B, FIG. 3C, and FIG. 3D illustrates a portion of a scanner assembly 300 in various configurations, such as facilitating full inspection coverage of an object under test using a pivoting inspection probe assembly 350A and an arm 370A coupled with a support frame 344. In FIG. 3A, the support frame 344 is mechanically coupled with a sliding arm 370A. The sliding arm 370A can support an inspection probe assembly 350A, such as coupled with the sliding arm 370A using a probe holder 372A. Generally, the sliding arm 370A can slide relative to the support frame 344, such as in a manner spring-loaded or actuated to force the sliding arm 370A toward an extended position as shown in FIG. 3A. The inspection probe assembly 350A can include various elements, such as an acoustic transducer array, a wedge structure for coupling the acoustic transducer array to the object under test, and a couplant flow path or manifold to provide couplant at an active surface of inspection probe assembly 350A, as illustrative examples. For example, the inspection probe assembly 350A can be modular. The inspection probe assembly 350A can include other features such as a manifold for application of a vacuum, such as to assist in recovering or constraining couplant flow.

The inspection probe assembly 350A can be pivotably coupled with the probe holder 372A. For example, the probe holder 372A can form a clevis or fork structure, with a pin 368A allowing the inspection probe assembly 350A to pivot. The probe holder 372A can extend away from the sliding arm 370A, such as to suppress mechanical interference between the sliding arm 370A and the object under test 358 as the inspection probe assembly 350A is translated or pivoted into position for scanning the object under test 358. In the example of FIG. 3A, the support frame 344 can be manipulated, such as by a robotic manipulator coupled to the support frame 344, with the support frame serving as an end effector. In this manner, the inspection probe assembly 350A can initially be translated toward an object under test 358 as shown by the arrows in FIG. 3A, such as with the inspection probe assembly 350A in a first orientation (e.g., an orientation parallel to the support frame 344 and perpendicular to a long axis of the sliding arm 370A, without yet pivoting relative to the probe holder 372A). In FIG. 3B, the support frame 344 can be rotated, with the inspection probe assembly 350A inclined relative to a surface of the object under test 358, such as while still in the first orientation relative to the sliding arm 370A and probe holder 372A. In this manner, the inspection probe assembly 350A can be aligned with its distal edge located past a leading edge 364 of the object under test 358 to avoid a collision with the leading edge 364.

In FIG. 3C, the distal edge of the inspection probe assembly 350A can contact a surface of the object under test 358, such as pivoting the inspection probe assembly 350A relative to the probe holder 372A about a pin 368A as the inspection probe assembly 350A is translated toward the surface of the object under test 358. For example, the support frame 344 can be manipulated, such as in a direction to force the inspection probe assembly 350A toward the surface of the object under test 358, with the sliding arm 370A transiting upward relative to the support frame 344 as shown by the arrows along the arm 370A. In this configuration, the inspection probe assembly 350A is pivoted to a second orientation relative to the probe holder 372A and is in contact with the surface of the object under test 358 at or near the leading edge 364 without having collided with the leading edge 364 during the sequence shown in FIG. 3A and FIG. 3B, leading to FIG. 3C. As an illustrative example, the sliding arm 370A can protrude through or otherwise past a plane defined by the support frame 344, as shown illustratively in FIG. 3C and FIG. 3D.

In FIG. 3D, the support frame 344 can be rotated to an orientation parallel to parallel to the surface of the object under test 358 and can be translated in a direction parallel to the surface of the object under test 358, such as to scan the inspection probe assembly 350A along the surface. A lift-off procedure can be similar to the sequence shown in FIG. 3A, FIG. 3B, FIG. 3C, and FIG. 3D, such as occurring at an end opposite the leading edge 364 or occurring back at the leading edge 364 if a scan is performed bi-directionally where the scanner assembly 300 is returned to an initial position, such as shown in FIG. 3A. Various portions of the scanner assembly 300 can be actuated or loaded. For example, the sliding arm 370A can be spring loaded by a spring 374 as shown in FIG. 3D, where the spring 374 biases the sliding arm 370A toward a distally extending position as shown in FIG. 3A. Similarly, the pivoting behavior of the inspection probe assembly 350A can be biased or can include features releasably locking the inspection probe assembly 350A in the first or second orientations using ball-detents or a cam arrangement, as illustrative examples. The present inventor has recognized, among other things, that the inspection probe assembly 350A deposit or lift-off sequence can be facilitated using passive features (e.g., a spring-loaded arm 370A) as shown illustratively in the sequence of FIG. 3A, FIG. 3B, FIG. 3C, and FIG. 3D, without requiring pneumatics or other actuators as a portion of the scanner assembly 300.

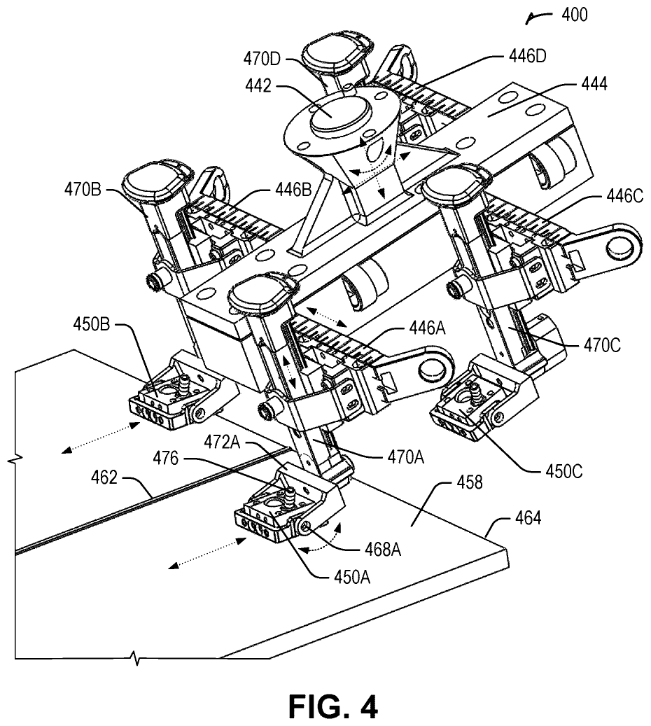

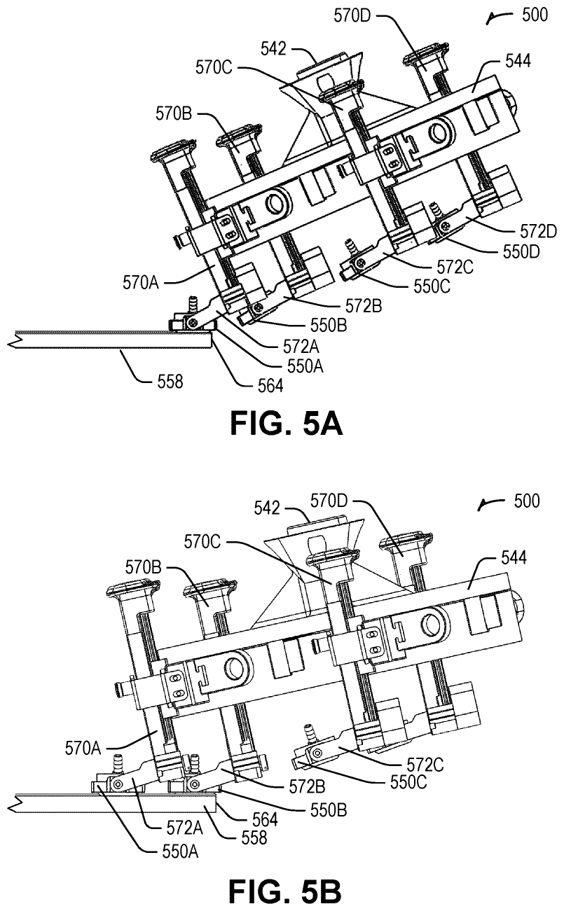

FIG. 4 illustrates generally an example comprising a scanner assembly 400 having a plurality of arms supporting corresponding inspection probe assemblies, such as having arms that can be operated in a manner similar to the configurations shown illustratively in FIG. 3A, FIG. 3B, FIG. 3C, FIG. 3D. In FIG. 4, the scanner assembly 400 can include a support frame 444, such as can manipulated by a robot coupled at an end effector coupling 442. The support frame can be mechanically coupled with a plurality of sliding arms, such as a first sliding arm 470A, a second sliding arm 470B, a third sliding arm 470C, and a fourth sliding arm 470D. The first sliding arm 470A, a second sliding arm 470B, a third sliding arm 470C, and a fourth sliding arm 470D can be mechanically coupled to the support frame 444 using respective fixed or adjustable lateral arms, such as shown as a first lateral arm 446A, a second lateral arm 446B, a third lateral arm 446C, and a fourth lateral arm 446D. Similar to the configurations shown illustratively in FIG. 3A, FIG. 3B, FIG. 3C, FIG. 3D, respective inspection probe assemblies can be coupled with corresponding sliding arms using a probe holder. For example, a first inspection probe assembly 450A can be pivotably coupled with a probe holder 472A, such as captive with a pin 468A. The first sliding arm 470A, the second sliding arm 470B, the third sliding arm 470C, and the fourth sliding arm 470D can be staggered such as in locations along a long axis of the support frame 444 as shown in FIG. 4. The first probe assembly 450A, a second probe assembly 450B, a third probe assembly 450C, and a fourth probe assembly can be deposited sequentially on a surface of an object under test 458, such as in a manner shown in the sequence of FIG. 3A, FIG. 3B, FIG. 3C, and FIG. 3D, or as shown and described below in FIG. 5A and FIG. 5B. A collision with a leading edge 464 of the object under test 458 can be avoided, while still providing specified coverage of structure being inspected, such as a longitudinal weld 462. In this manner, the scanner assembly 400 can provide inspection coverage as described above in relation to FIG. 2A and FIG. 2B, without loss of coverage in the region 226 of FIG. 2A.

As mentioned above, the first inspection probe assembly 450A, as an illustrative example, can be modular, such as including an acoustic transducer array, an acoustic coupling wedge, and a couplant path, such as defining or including a couplant manifold fed by a couplant port 476 (e.g., for water or another acoustic couplant medium to flow to a region between the first inspection probe assembly 450A and the object under test 458). In the illustrative example of the detailed view of the scanner assembly 400 of FIG. 4, arrows show degrees of freedom or directions of movement of various portions of the scanner assembly, such as translation of the first inspection probe assembly 450A toward or away from the support frame 444 using sliding of the first sliding arm 470A. Different inspection configurations can be established such as to position the one or more inspection probe assemblies relative to the weld 462 or other structure to be inspected, such as by movement of the first sliding arm 470A, the second sliding arm 470B, the third sliding arm 470C, or the fourth sliding arm 470D.

FIG. 5A and FIG. 5B illustrate generally an example comprising a scanner assembly similar to FIG. 4, shown in two different configurations, such as to provide deployment or lift-off of respective inspection probe assemblies. In FIG. 5A, a support frame 544 is rotated and translated toward at object under test 558. A first inspection probe assembly 550A can pivot from a first orientation to a second orientation relative to a first probe holder 572A as a first sliding arm 570A slides toward the support frame 544, such as when the first inspection probe assembly 550A contacts the object under test 558. Other inspection probe assemblies, such as a second inspection probe assembly 550B coupled to a second sliding arm 570B using a second probe holder 572B can be independent of the first inspection probe assembly 550A. For example, the second inspection probe assembly 550B, a third inspection probe assembly 550C, and a fourth inspection probe assembly 550D can remain in a first orientation relative to their corresponding second probe holder 572B, third probe holder 572C, and fourth probe holder 572D, respectively, and the second sliding arm 570B, a third sliding arm 570C, and a fourth sliding arm 570D can remain extended. As mentioned above, the first sliding arm 570A, the second sliding arm 570B, the third sliding arm 570C, and the fourth sliding arm 570D can each be spring-loaded or otherwise actuated to remain in an extended configuration until loaded, such as displaced by upward pressure after deposit of a corresponding inspection probe on the object under test 558.

In the example of FIG. 5B, the scanner assembly 500 is translated diagonally toward object under test 558 and rotated clockwise in the plane of the page, such as using a robotic manipulator coupled with the end effector coupling 542, and the second inspection probe assembly 550B has touched down on the surface of the object under test 558 without colliding with the leading edge 564. The scanner assembly 500 can continue to translate diagonally providing touch-down of the third inspection probe assembly 550C and fourth inspection probe assembly 550D in a similar manner, gradually rotating each of the inspection probes back to a first orientation where each respective inspection probe is perpendicular to its corresponding sliding arm. Each sliding arm, including the first sliding arm 570A, the second sliding arm 570B, the third sliding arm 570C, and the fourth sliding arm 570D, can be displaced sequentially as each corresponding inspection probe touches down. A lift off procedure can invert the sequence of operations described above, such as back at the leading edge 564 after the scanner assembly has traversed the object under test 558, or at an opposite end of the object under test 558. Generally, in the examples of FIG. 5A and FIG. 5B, the support frame 544 can be inclined relative to a surface of the object under test 558 to either provide inspection probe assembly deployment or lift-off, to assist in avoiding collision with an edge of the object under test 558 such as the leading edge 564.

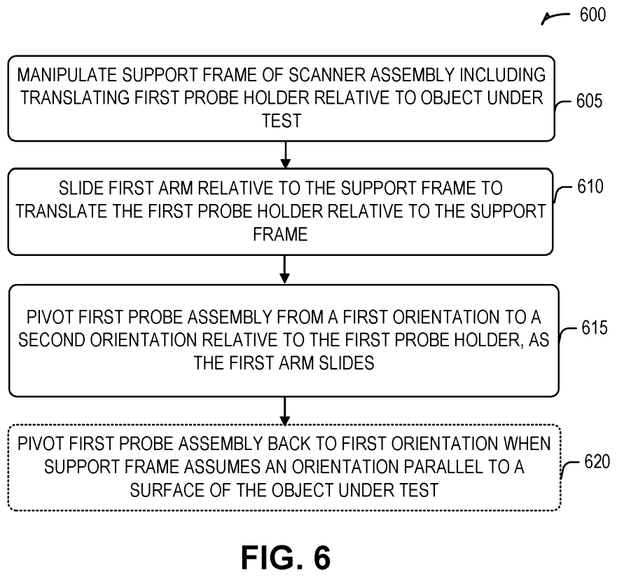

FIG. 6 illustrates generally a technique 600, such as an automated method, that can include manipulating a support frame of a scanner assembly, amongst other operations. For example, the technique can include at 605 manipulating a support frame of a scanner assembly such as to translate the support frame toward an object under test. For example, such manipulation can include using a robotic manipulator or other actuator. As mentioned above, the support frame can be mechanically coupled to a sliding arm. For example, at 610, a first sliding arm can be slid relative to the support frame to translate a first inspection probe holder relative to the support frame. For example, a first inspection probe assembly can be captive in the first inspection probe holder, and the first inspection probe holder can be mechanically coupled to the first sliding arm. When the first inspection probe contacts an object under test, the first sliding arm can be displaced, such as sliding toward the support frame (or therethrough, for example). At 615, the first inspection probe assembly can be pivoted relative to the first inspection probe holder, such as contemporaneously with the sliding of the first sliding arm. For example, the first inspection probe assembly can touch down upon a surface of the object under test and rotate relative to the first inspection probe holder and support frame. Such pivoting can occur in part due to the support frame being rotated (e.g., inclined) relative to the surface of the object under test, while the first inspection probe assembly remains in contact and generally parallel with the surface of the object under test. At 620, the support frame can be rotated to an orientation generally parallel with the object under test, and the first probe assembly can remain generally in contact and generally parallel with the surface of the object under test, such as returning to the first orientation relative to the inspection probe holder. For example, the first orientation can be an orientation parallel to the inspection probe holder, and the second orientation can be an orientation inclined with respect to the inspection probe holder.

### VARIOUS NOTES

Each of the non-limiting aspects above can stand on its own or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc., are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like. The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A scanner assembly for performing non-destructive test (NDT), the scanner assembly comprising:
a support frame;
a first probe holder;
a first probe assembly mechanically coupled with the first probe holder and configured to pivot relative to the first probe holder; and
a first arm mechanically coupled to the support frame and configured to slide relative to the support frame to translate the first probe holder relative to the support frame;
wherein the first probe assembly pivots from a first orientation to a second orientation as the first arm slides, to align the first probe assembly in the second orientation to scan an object under test.

2. The scanner assembly of claim 1, wherein the first orientation comprises an inclined orientation relative to a surface of the object under test, and the second orientation comprises an orientation parallel to the surface of the object under test.

3. The scanner assembly of claim 1, wherein the first probe assembly comprises at least one acoustic transducer.

4. The scanner assembly of claim 1, wherein the first probe holder provides an offset between the first probe assembly and the first arm to suppress mechanical interference between the first probe assembly and the first arm as the first probe assembly pivots.

5. The scanner assembly of claim 4, wherein the first probe holder comprises a fork structure configured to hold the first probe assembly.

6. (canceled)

7. The scanner assembly of claim 1, wherein the first arm is configured to translate the first probe holder toward or away from the support frame.

8. The scanner assembly of claim 1,
a second probe holder;
a second probe assembly mechanically coupled with the second probe holder and configured to pivot relative to the second probe holder to provide an inclination of the second probe assembly relative to a surface of an object under test; and
a second arm mechanically coupled to the support frame and configured to slide relative to the support frame to translate the second probe holder relative to the support frame;
wherein the second probe assembly pivots from a first orientation to a second orientation as the second arm slides, to align the second probe holder in the second orientation to scan the object under test without colliding with an end of the object under test.

9. The scanner assembly of claim 8, wherein the second probe holder pivots independently of the first probe holder.

10. The scanner assembly of claim 8, wherein the second probe holder is located in a different position along the support frame relative to the first probe holder and the end of the object under test.

11. (canceled)

12. The scanner assembly of claim 1, wherein the support frame and first probe assembly are configured to assume an orientation parallel to a surface of the object under test after the first probe assembly touches down on the surface of the object under test.

13. The scanner assembly of claim 1, comprising a plurality of probe holders, corresponding probe assemblies, and corresponding arms, of which the first probe holder, first probe assembly, and first arm comprise respective ones of the plurality of probe holders, corresponding probe assemblies, and corresponding arms.

14. The scanner assembly of claim 1, comprising a sensor separate from the probe assembly, the sensor configured to determine one or more attributes of the object under test.

15. (canceled)

16. A method for performing non-destructive test (NDT) using a scanner assembly, the method comprising:
robotically manipulating a support frame of the scanner assembly, the support frame coupled to a first arm, the first arm coupled to a first probe holder, the manipulating comprising translating the support frame toward an object under test;
sliding the first arm relative to the support frame to translate the first probe holder relative to the support frame; and
pivoting the first probe assembly from a first orientation to a second orientation relative to the first probe holder, as the first arm slides, to align the first probe assembly in a second orientation to scan the object under test without colliding with an end of the object under test;
wherein the first orientation comprises an inclined orientation relative to a surface of the object under test, and the second orientation comprises an orientation parallel to the surface of the object under test.

17. The method of claim 16, comprising pivoting the first probe assembly back to the first orientation relative to the first probe holder while maintaining the first probe assembly in an orientation parallel to the surface of the object under test.

18. The method of claim 16, comprising manipulating the support frame of the scanner assembly to scan the first probe assembly along the surface of the object under test after the first probe assembly is aligned in an orientation parallel to the object under test.

19. The method of claim 16, wherein the scanner assembly comprises a plurality of probe holders, corresponding probe assemblies, and corresponding arms, of which the first probe holder, first probe assembly, and first arm comprise respective ones of the plurality of probe holders, corresponding probe assemblies, and corresponding arms; and
wherein the method comprises performing acoustic inspection with the probe assemblies.

20. The method of claim 19, wherein the performing the acoustic inspection comprises using the first probe assembly in a transmit mode, and another probe assembly amongst the corresponding probe assemblies in a receive mode.

21. The method of claim 16, comprising performing acoustic inspection of a longitudinal weld structure using the scanner assembly.

22. The method of claim 16, comprising:
performing lift-off of the first probe assembly from the surface of the object under test including sliding the first arm relative to the support frame to translate the first probe holder relative to the support frame, as the first probe assembly pivots from the second orientation to the first orientation as the first arm slides; and
robotically manipulating the support frame to translate the first probe assembly away from the surface of the object under test.

23. The method of claim 16, comprising determining one or more attributes of the object under test using a sensor separate from the first probe assembly.

24-25. (canceled)
